(19) United States
(12) Patent Application Publication
(10) Pub. No.: US 2011/0249445 A1
(43) Pub. Date: Oct. 13, 2011

(54) PARABOLIC REFLECTOR AND RELATIVE LED LIGHTING DEVICE

(75) Inventors: Giuseppe Vasta, NOVATE MILANESE (MI) (IT); Luca Meneghetti, DESIO (MB) (IT)

(73) Assignee: KHATOD OPTOELECTRONIC SRL, Cinisello Balsamo (MI) (IT)

(21) Appl. No.: 13/082,919

(22) Filed: Apr. 8, 2011

(30) Foreign Application Priority Data
Apr. 9, 2010 (IT) MI2010A000592

(51) Int. Cl. F21V 7/06; G02B 5/10

(52) U.S. Cl. 362/296.08; 359/853

(57) ABSTRACT

Axial symmetric parabolic reflector comprising an opening and which is positionable in a position in which it surround the at least a led lighting source for reflect and distribute in homogeneous way a light flux toward the opening. The axial symmetric parabolic reflector comprises a mask which is made integral with the same, besides the mask being positionable in proximity of the at least a led lighting source in a way to results substantially orthogonal to a longitudinal direction in order to avoid the direct eyesight of the at least a led lighting source through the opening.

The mask further comprises a reflecting surface which includes a reflecting axial symmetric groove having a section substantially shaped as a “3”, and besides at least a filter or a lens in order to avoid the glare by indirect light of the at least a led lighting source.

### FIELD OF INVENTION

The present invention refers to a parabolic reflector and to a relative led lighting device, in particular usable as led downlight or as led lamp.

### SUMMARY OF THE INVENTION

The present invention refers to an axial symmetric parabolic reflector for a led lighting device provided with at least a led lighting source.

The axial symmetric parabolic reflector comprises an opening and it is positionable in a position in which it surround the at least a led lighting source for reflect and distribute in homogeneous way a light flux toward the opening.

The axial symmetric parabolic reflector comprises a mask which is made integral with the same, besides the mask being positionable in proximity of the at least a led lighting source in a way to results substantially orthogonal to a longitudinal direction in order to avoid the direct eyesight of the at least a led lighting source through the opening.

The mask comprises a reflecting surface which includes a reflecting axial symmetric groove having a section substantially shaped as a “3” in order to obtain an high luminous efficiency.

The axial symmetric parabolic reflector comprises besides at least a filter or a lens in order to avoid the glare by indirect light of the at least a led lighting source.

Purpose of the present invention is to realize a parabolic reflector for a led lighting device and a relative led lighting device that avoid to glare a person with a direct led light and at the same time that permit to have an homogeneous light distribution.

Another purpose is to realize a parabolic reflector for a led lighting device and a relative led lighting device which avoid to glare a person and having at the same time a reduced number of components.

Still another purpose is to realize a parabolic reflector for a led lighting device and a relative led lighting device that can be easy to produce.

Further purpose is to realize a parabolic reflector for a led lighting device and a relative led lighting device that can be economically advantageous.

These purposes according to the present invention are reached realizing a parabolic reflector for a led lighting device and a relative led lighting device according to claim 1 and 12.

Further features of the invention are pointed out in the following claims.

### BRIEF DESCRIPTION OF THE DRAWINGS

The features and the advantages of a parabolic reflector for a led lighting device and of a relative led lighting device according to the present invention will appear more evident from the following illustrative and not limitative description, referred to the attached schematic drawings in which:

FIG. 1 is a raised lateral right side perspective top view of a preferred form of embodiment of a parabolic reflector for a led lighting device according to the present invention;

FIG. 2 is a top view of the parabolic reflector of FIG. 1;

FIG. 3 is a sectioned raised frontal view of a preferred form of embodiment of a parabolic reflector according to the present invention;

FIG. 4 is a sectioned raised frontal view of another form of embodiment of a parabolic reflection according to the present invention;

FIG. 5 is an exploded raised frontal view of a preferred form of embodiment of a led lighting device provided with a parabolic reflector according to the present invention.

### DETAILED DESCRIPTION OF THE PREFERRED EMBODIMENTS

With reference to the figures, it is shown an axial symmetric parabolic reflector 30 for a led lighting device 10 provided with at least a led lighting source 20, said axial symmetric parabolic reflector 30 comprises an opening 35 and besides it is positionable in a position in which it surround said at least a led lighting source 20 for reflect and distribute in homogeneous way a light flux toward said opening 35.

According to the present invention said parabolic reflector 30 comprises a mask 40 which is made integral with the same, preferably through a plurality of connection elements 42 having an elongated shape, and besides said mask 40 being positionable in proximity of said at least a led lighting source 20 in a way to results substantially orthogonal to a longitudinal direction 90 in order to avoid the direct eyesight of said at least a led lighting source through said opening 35.

Advantageously in this way, said mask 40 improves the luminous distribution of the led lighting device 10, and also it permit to reduce the brilliance of said light flux, hence reducing the possibility to glare a person which is caused by the direct light emitted by said at least a led lighting source 20.

Preferably said parabolic reflector 30 and said mask 40 are realized in just one piece in a polymeric material, as for example polycarbonate and/or its derivates, which is superficially metalized for having a reflective surface able to reflect and diffuse said light flux of said at least a led lighting source 20.

Advantageously this permit a reduction of the components, a reduction of the total weight and an easy production in series accompanied by an high productivity, and hence with a reduced cost.

Preferably said mask 40 is provided with a reflecting portion 45 which is faceable in proximity to at least a led lighting source 20, said reflecting portion 45 being provided of a portion substantially shaped as a cusp, in particular which is protuberance substantially shaped as a cusp which protrudes from said reflecting portion 45, for reflect a light flux laterally toward said parabolic reflector 30.

Advantageously this permit to increase the luminous efficiency of the led lighting device 10 avoiding at the same time a glare cause by direct light of a person.

Besides said reflecting portion 45 is able to collaborate with said parabolic reflector 30 and permits to mix and to distribute the light flux in homogeneous way on a greater surface, hence through said opening 35 of said parabolic reflector 30 come out a light flux having a reduced brilliance.

Preferably said mask 40 comprises an axial symmetric groove 47 substantially shaped as a “3” which is realized in said reflecting portion 45.

In particular said parabolic reflector 30 is mountable directly on an electronic board 50 comprising said at least a led lighting source 20, in such a way that said reflecting axial symmetric groove 47 of said mask 40 face toward to said at least a led lighting source 20.

Advantageously this form has shown from the experimental point of view an high luminous efficiency and permit to reduce the number of components avoiding the need of supporting element between said parabolic reflector 30 and said electronic board 50.

In particular said mask 40 results substantially coaxial with a second opening 48 of said parabolic reflector 30 and besides it is positioned in proximity of the same, said second opening 48 permit a correct coupling of said parabolic reflector 30 with said electronic board 50 avoiding that the same interfere with said at least a led lighting source 20.

Preferably said parabolic reflector 30 comprises at least an housing 34, of a filter or of a lens, preferably annular or rectangular, which is positioned in proximity of said opening 35.

Advantageously this permit to insert easily at least a lens or a filter for prevent the entrance of dust or water in said led lighting device.

Besides preferably said parabolic reflector 30 comprises at least a filter or a lens for limit the indirect glare caused by indirect light of the at least a led lighting source 20 which is reflected by said parabolic reflector 30.

Besides said at least an housing 34 comprises preferably a seat for a polymeric gasket in order to make said led lighting device 10 water proof, advantageously in a way to use the same for external illumination.

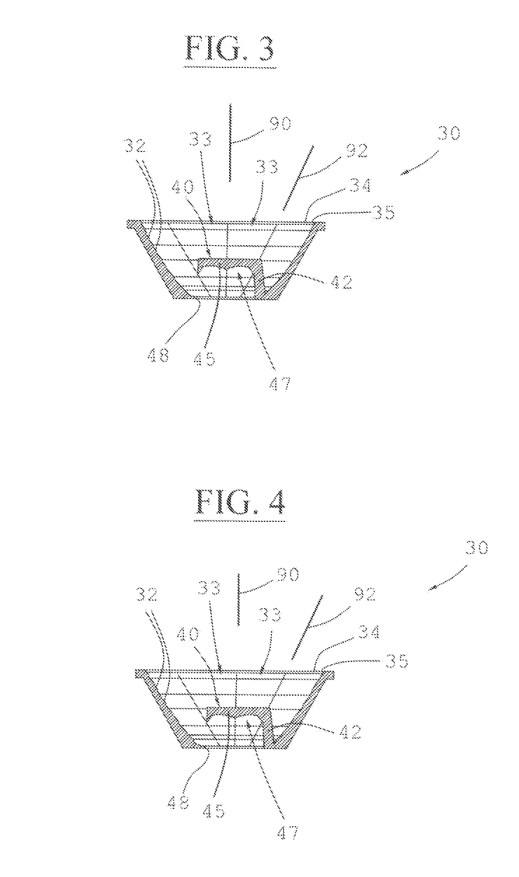

Preferably said parabolic reflector 30 comprises internally a form substantially shaped as a truncated pyramid having with a regular polygonal base, as shown in the FIGS. 3 and 4.

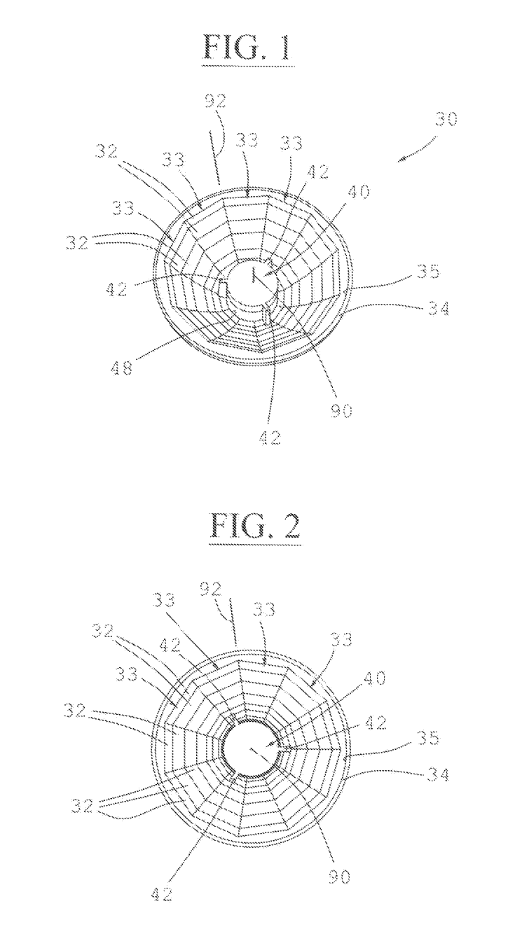

In particular said parabolic reflector 30 comprises internally a form which lines are substantially shaped as a spider web, as shown in FIGS. 1 and 2.

Advantageously this permit to obtain a better directioning of the luminous flux.

Besides said parabolic reflector 30 is preferably internally divided in a plurality of radial sector 33, in particular it is divided preferably in at least 11 radial sector 33, in particular in at least 20 radial sector 33.

This permit advantageously to redistribute homogenously the light flux, also reducing the problem of an indirect glare of a person.

Preferably each radial sector 33 comprising a plurality of protuberances or grooves 32, in particular substantially shaped as “(” which are positioned one adjacent to the others along a direction 92 parallel to a generatrix of said truncated pyramid.

Advantageously this permit to obtain an high homogeneous luminous distribution of light flux and with a reduced brilliance.

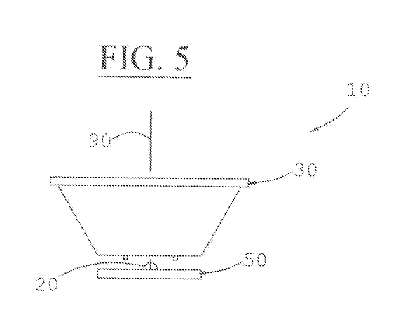

With reference to FIG. 5, according to another aspect of the present invention it is furnished a led lighting device 10 comprising at least a led lighting source 20 which produce a light flux along a longitudinal direction 90 and comprising at least a parabolic reflector 30 according of the type previously described.

Preferably said at least a led lighting source 20 comprises a power of at least 1 W, in particular of at least 3 W.

Preferably said led lighting device 10 comprises at least a filter or a lens positioned in said at least an housing 34 and in particular also a annular polymeric gasket in order to prevent the entrance of water inside to said led lighting device 10.

Advantageously in this way through at least a filter it is possible reduce at the minimum the possibility also of a glare by reflected light or indirect, reducing at the minimum the brilliance of the led lighting device 10.

Advantageously through said mask 40 provided of said reflecting portion 45, in particular provided of said axial symmetric reflecting groove 47, and through said at least a filter or lens it is possible to reduce at the minimum the possibility of a glare of a person, as with direct or indirect light, maintaining at the same time the same total luminous efficiency as in the case of led lighting device without mask 40.

In this way it has been seen that a parabolic reflector for a led lighting device and a relative led lighting device according to the present invention achieves the objectives previously mentioned.

The parabolic reflector for a led lighting device and the relative led lighting device of the present invention thus conceived can undergo to numerous modifications and variations, all included in the same inventive concept.

Furthermore, in practice the materials used, as well as their dimensions and the components, can vary according to the technical needs.

1. Axial symmetric parabolic reflector (30) for a led lighting device (10) provided with at least a led lighting source (20), said axial symmetric parabolic reflector (30) comprises an opening (35) and it is positionable in a position in which it surround said at least a led lighting source (20) for reflect and distribute in homogeneous way a light flux toward said opening (35), said parabolic reflector (30) characterized by comprising a mask (40) which is made integral with the same, besides said mask (40) being positionable in proximity of said at least a led lighting source (20) in a way to results substantially orthogonal to a longitudinal direction (90) in order to avoid the direct eyesight of said at least a led lighting source through said opening (35).

2. Parabolic reflector (30) according to claim 1, characterized in that said parabolic reflector (30) and said mask (40) are realized in just one piece in a polymeric material, as for example polycarbonate and/or its derivates.

3. Parabolic reflector (30) according to claim 1, characterized in that said mask (40) is provided with a reflecting portion (45) which is faceable in proximity to at least a led lighting source (20).

4. Parabolic reflector (30) according to claim 3, characterized in that said reflecting portion (45) being provided of a portion substantially shaped as a cusp in order to reflect a light flux laterally toward said parabolic reflector (30).

5. Parabolic reflector (30) according to claim 3, characterized in that said reflecting portion (45) is able to collaborate with said parabolic reflector (30) and permits to mix and distribute the light flux in homogeneous way on a greater surface, in such a way that hence through said opening (35) of said parabolic reflector (30) come out a light flux having a reduced brilliance.

6. Parabolic reflector (30) according to claim 3, characterized in that said mask (40) comprising an axial symmetric groove (47) substantially shaped as a “3” which is realized in said reflecting portion (45).

7. Parabolic reflector (30) according to claim 1, characterized in that said parabolic reflector (30) is mountable directly on an electronic board (50) comprising said at least a led lighting source (20), in such a way that said reflecting axial symmetric groove (47) of said mask (40) face toward to said at least a led lighting source (20).

8. Parabolic reflector (30) according to claim 1, characterized by comprising at least an housing (34) of a filter or of a lens, which is positioned in proximity of said opening (35).

9. Parabolic reflector (30) according to claim 8, characterized in that said at least an housing (34) comprising a seat for a polymeric gasket in order to make said led lighting device (10) water proof.

10. Parabolic reflector (30) according to claim 1, characterized by comprising internally a shape substantially as a truncated pyramid with a regular polygonal base, and besides said parabolic reflector (30) is internally divided in a plurality of radial sector (33), in particular it is divided in at least 11 radial sector (33).

11. Parabolic reflector (30) according to claim 10, characterized in that each radial sector (33) comprising a plurality of protuberances or grooves (32) substantially shaped as “(” which are positioned one adjacent to the others along a direction (92).

12. Led lighting device (10) comprising at least a led lighting source (20) which produce a light flux along a longitudinal direction (90) and comprising at least a parabolic reflector (30) according to claim 1.

13. Led lighting device (10) according to claim 12, characterized in that said at least a led lighting source (20) shows a power of at least 1 W, in particular of at least 3 W.

14. Led lighting device (10) according to claim 12, characterized by comprising at least a filter or a lens positioned in said at least an housing (34).
